(19) United States
(12) Patent Application Publication
(10) Pub. No.: US 2009/0107083 A1
(43) Pub. Date: Apr. 30, 2009

(54) Multicategory Collection of Ceiling/Wall Devices With Familial Appearances

(76) Inventors: Ray Call, Mission Viejo, CA (US); Scott Struthers, San Clemente, CA (US); Geoff Spencer, San Juan Capistrano, CA (US)

Correspondence Address: FISH & ASSOCIATES, PC;ROBERT D. FISH, 2603 Main Street, Suite 1000, Irvine, CA, 92614-6232, US

(21) Appl. No.: 12/335,722

(22) Filed: Dec. 16, 2008

Related U.S. Application Data
(63) Continuation-in-part of application No. 12/202,870, filed on Sep. 2, 2008.
Application No. 12/202,870 is a continuation-in-part of application No. 11/954,667, filed on Dec. 12, 2007, now Pat. No. 7,461,483.
Application No. 11/954,667 is a continuation-in-part of application No. 11/566,365, filed on Dec. 4, 2006.
Application No. 11/566,365 is a continuation-in-part of application No. PCT/US07/16404, filed on Jul. 19, 2007.
Application No. PCT/US07/16404 is a continuation of application No. 11/548,381, filed on Oct. 11, 2006.
(60) Provisional application No. 60/950,237, filed on Jul. 17, 2007.
(60) Provisional application No. 60/825,162, filed on Sep. 11, 2006.
(60) Provisional application No. 60/950,237, filed on Jul. 17, 2007.

(51) Int. Cl. H02G 3/36

(52) U.S. Cl. 52/745.21; 52/27

(57) ABSTRACT

Devices that are mounted onto building surfaces can generally be divided into the following categories: speakers, lighting, controllers, air vents, power/data interfaces, fire response interfaces, and cameras. Typically, all of these devices have very different appearances, since they are made by different companies. Here, an installer takes components from at least three different categories, and installs them on surfaces of a building so that they all share the same appearance.

This application is a continuation-in-part of non-provisional application Ser. No. 12/202,870 filed Sep. 2, 2008. Ser. No. 12/202,870 is a continuation-in-part of non-provisional application Ser. No. 11/954,667 filed Dec. 12, 2007. Ser. No. 11/954,667 is a continuation-in-part of non-provisional application Ser. No. 11/566,365 filed Dec. 4, 2006, and Ser. No. 11/954,667 also claims priority to (1) provisional application Ser. No. 60/950,237 filed Jul. 17, 2007 and (2) International application ser. no. PCT/US07/16404 filed Jul. 19, 2007. Ser. No. 11/566,365 claims priority to provisional application Ser. No. 60/825,162 filed Sep. 11, 2006. PCT/US07/16404 claims priority to (1) non-provisional application Ser. No. 11/548,381 filed Oct. 11, 2006, (2) provisional application 60/825,162 filed Sep. 11, 2006, and (3) provisional application 60/950,237 filed Jul. 17, 2007. All prior applications are incorporated by reference in their entirety.

### FIELD OF THE INVENTION

The field of the invention is wall mount coverings.

### BACKGROUND

Mounted components, including for example, plasma screens, speakers, power outlets, air vents, electrical outlets, recessed lighting, fire sprinklers, cameras, junction boxes, have all been mounted in various ways to structural barriers in walls or ceilings. Such components can generally be divided into eight distinct categories: speakers, lighting, controllers, air vents, power/data interfaces, fire response devices, cabinetry, and cameras. Since companies typically only make components that fall into one category, buildings with components from different categories tend to have a disjointed look and feel. For example, lighting installed in a ceiling generally has a different appearance from a speaker installed in a wall, which then tends to have a different appearance from a power outlet installed in a wall.

The problem is that while most buildings have a different appearance for each different category of components, owners, architects, interior designers and others may prefer to have a common familial appearance for such components throughout an entire room, or even an entire structure.

U.S. Pat. No. 6,913,369 to Chadwick teaches a method of creating wall or ceiling mounting flanges that can be used with different types of components, for example sconces, valances, niches, and shelves. However, despite the commonality of the mounting flanges, Chadwick fails to teach that the components have a common familial appearance. In fact, Chadwick specifically teaches that components from different categories have very different appearances. Chadwick and all other extrinsic materials identified herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need in the art for systems and methods of installing components to a structural barrier that presents a common familial appearance.

### SUMMARY OF THE INVENTION

The present invention provides apparatus and methods in which components from different categories are installed in a building so that they share a common familial appearance. As used herein, the term “category” means one of the following groupings: speakers, lighting, controllers, air vents, power/data interfaces, fire response devices, cabinetry, and cameras. As the terms are used herein, controllers include any device that sends commands to another device, and fire response devices include both fire alarms and fire sprinklers. In preferred embodiments, components from at least two different categories are given a common familial appearance, and in more preferred embodiments, components from at least three, at least four or at least five different categories are given a common familial appearance

A “common familial appearance” is defined herein to be one or more visual features that, when combined, distinguish the component as one that belongs in a given family of products. By way of example, the features of a common familial appearance could include a non-traditional three dimensional or two dimensional shape, a distinctive logo or graphic design, a distinctive color or combination of colors used, a distinctive finish applied to the surface of the component, or any combination thereof. Familial appearances of particular interest include flush-mounts, oval faceplates, star-shaped faceplates, polygon faceplates, heart faceplates, logos shown prominently, a substantial prominence from the wall, a pattern across a surface of the component, and a finish applied to a surface of the component. Traditional shapes, for example a protruding rectangular flange around a wall outlet, or a circular protruding flange around a recessed light, are not considered distinctive for purposes of this application. Components within the same family do not need to have the same dimensions, size, or position of openings to have a common familial appearance.

One method of achieving a common familial appearance to different types of components is by using face plates that impart the common familial appearance. Each face plate is preferably greater than 25 in² with an opening for the component of at least 5 in².

Another method of achieving a common familial appearance is to install the components in manufactured panels, with pre-installed brackets that flush-mounts the components or their corresponding face plates. Flush mounting could be achieved in part using a spackle rim around the opening(s). One family of panels, for example, could achieve a common familial appearance by having all heart-shaped openings, while another family of panels could achieve a common familial appearance by having an outcropping of a particular 3-D logo or design below each opening. Additionally or alternatively, different families of panels could achieve different common familial appearances by employing different bracket sizes, different numbers of openings, or even different numbers of openings in different positions from one another.

A common familial appearance could be shared by multiple components installed in the same structural barrier, or in different structural barriers. For example a television, speaker, and cabinetry could be installed on a wall, and light fixtures and fire sprinklers having the common familial appearance could be installed on a ceiling. In that manner structural barrier components of an entire room could share a common familial appearance. In one contemplated embodiment, all of the power outlets, controls, televisions, and speakers in a child's room could have a border that displays the child's name. In another contemplated embodiment, all of the structural barrier components in a kitchen could share a common logo, shape and/or color(s) associated with the building manufacturer or architect.

As used herein, the term “structural barrier” should be construed broadly to mean any sort of mechanical barrier used as a ceiling, wall, door, or floor. Structural barriers can be made of any suitable material, including for example plywood, plaster, wood, wood pulp, gypsum, stone, concrete, brick, and so forth. Structural barriers can be supporting or non-supporting, so that even acoustic tiles used in a ceiling would be considered structural barrier as the term is used herein. Similarly, wooden logs that form a wall in a log house would be considered a structural barrier as the term is used herein. Subsets of structural barriers include ceiling/wall structural barriers (i.e. barriers used as ceilings and/or floors), and wall structural barriers (i.e. barriers used as walls).

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1A is a front perspective view of a prior art power outlet.

FIG. 1B is a simplified vertical cross-section of the power outlet of FIG. 1A, taken along line 1B-1B.

FIG. 2A is a front perspective view of a prior art touch screen.

FIG. 2B is a simplified vertical cross-section of the touch screen of FIG. 2A, taken along line 2B-2B.

FIG. 3A is a front perspective view of the power outlet of FIG. 1A, where the facia plate has been modified or replaced to have a common familial appearance with touch screen of FIG. 4A.

FIG. 3B is a simplified vertical cross-section of the power outlet of FIG. 3A, taken along line 3B-3B.

FIG. 4A is a front perspective view of the touch screen of FIG. 2A, where the facia plate has been modified or replaced to have a common familial appearance with the power outlet of FIG. 3A.

FIG. 4B is a simplified vertical cross-section of the touch screen of FIG. 4A, taken along line 4B-4B.

FIG. 5 is an exploded view of a panel, bracket, component, and logo according to one embodiment.

FIG. 6 is a plan view of a panel having three openings, with a bracket disposed within each opening.

FIG. 7 is a front perspective view of one of the brackets in FIG. 6.

FIG. 8 is a simplified vertical cross-section of the panel and one of the brackets of FIG. 6, taken along line 9-9, installed in a wall and with an attached component.

FIG. 9 is a blown up view of the circled portion of FIG. 8 around circle 11.

FIG. 10A is a front perspective view of the bracket of FIG. 8 positioned to couple with a bracket backing.

FIG. 10B is a simplified vertical cross-section of the panel of FIG. 6, taken along line 9-9, with the bracket and bracket backing of FIG. 10A.

FIG. 11A is a front perspective view of a panel being affixed to two studs in a wall, the panel having a spackle shield covering the openings.

FIG. 11B is a front perspective view of the panel of FIG. 11A, around which drywall has been installed.

FIG. 11C is a front perspective view of the panel and drywall of FIG. 11B, showing mesh tape.

FIG. 11D is a front perspective view of the panel and drywall of FIG. 11C, where the mesh tape has been covered by spackle.

FIG. 11E is a front perspective view of the panel and drywall of FIG. 11C, where the spackle shields have been removed to show the openings.

FIG. 12A is a perspective view of two structures in a building (e.g. walls or wall and ceiling), in which an opening has been cut to receive a panel assembly.

FIG. 12B is a perspective view of the two structures of FIG. 12A, in which the panel assembly has been placed within the opening.

FIG. 12C is a perspective view of the two structures of FIG. 12B, in which the approximated edges of the panel assembly and the wall have been finished to provide a superficially continuous junction.

FIG. 12D is a perspective view of the two structures of FIG. 12C, in which the second wall has a second panel assembly with an installed component.

FIG. 13 is a rear view of the panel assembly of FIGS. 12A-12D, showing a receiver and attachments.

FIG. 14 is a perspective view of a panel assembly being formed by pouring a panel material into a mold.

### DETAILED DESCRIPTION

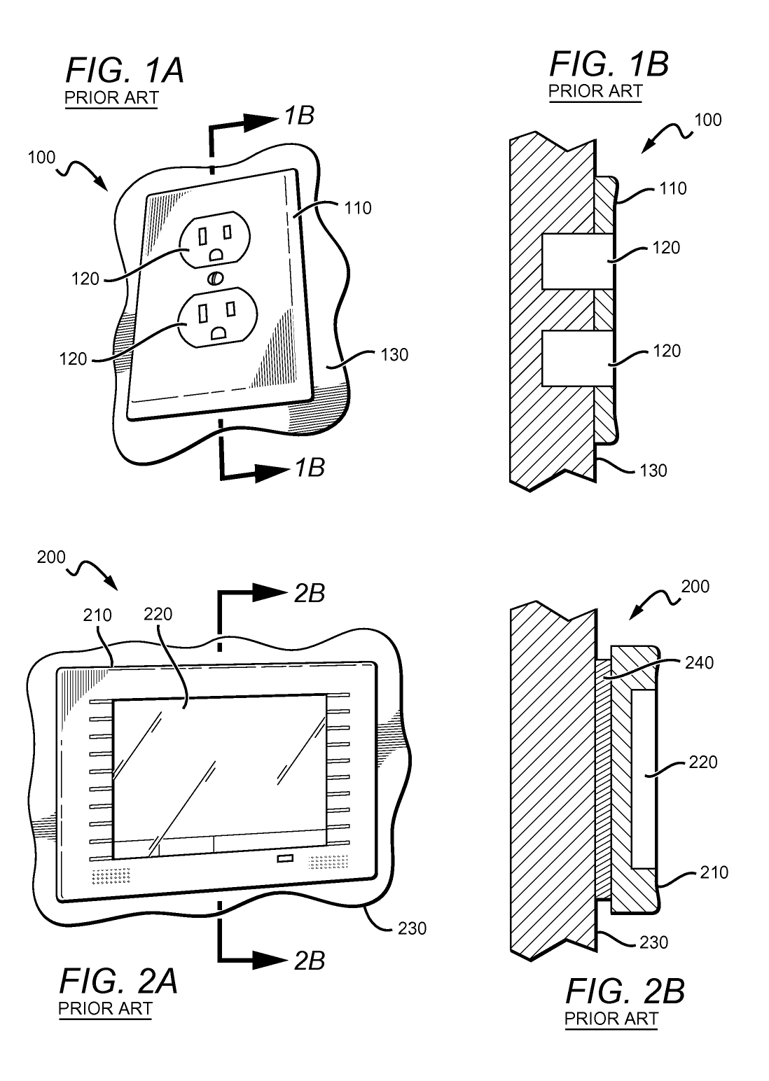

In FIGS. 1A-1B, a prior art power outlet 100 is generally mounted to a structural barrier 130, and has a facia plate 110 with one or more female electrical connectors 120. As used herein, the term “to” with respect to mounting of an object with respect to a structural barrier should be interpreted generically as including instances where the object is being mounted “on”, “onto”, “on top of”, or “in” the structural barrier, unless the context dictates otherwise.

Facia plate 110 has a flange that is mounted over the female electrical connectors 120 to fit over an opening (not shown) in structural barrier 130, and rest on the structural barrier's surface. This causes facia plate 110 and female electrical connectors 120 to protrude slightly outward from the surface of the structural barrier, as can be seen in FIG. 1B, giving the facia plate a curved prominence. It should be appreciated that power outlet 100 is used euphemistically to represent any mounted component in the category of power and data interfaces, for example Ethernet ports, A/V jacks, telephone jacks, and fiber optic jacks.

In FIGS. 2A-2B, a prior art touch screen 200 is generally mounted to a structural barrier 230 using screen mount 240, and has a facia plate 210 and a screen 220. This causes both facia plate 210 and screen 220 to protrude outward from the surface of the structural barrier. It should be appreciated that touch screen 200 is used euphemistically to refer to any mounted component in the category of controllers, including, for example, dimmers, flip-switches, keypads, thermostats, and push-push switches.

Touch screen 200 has a different familial appearance from power outlet 100, since both are mounted to the wall in different ways and don't share any distinguishing characteristics. For example, both power outlet 100 and touch screen 200 are substantially rectangular, and protrude from the wall. But those are not distinguishing features because they are commonplace, and therefore would not serve to distinguish those components as being ones that belongs in a given family of products.

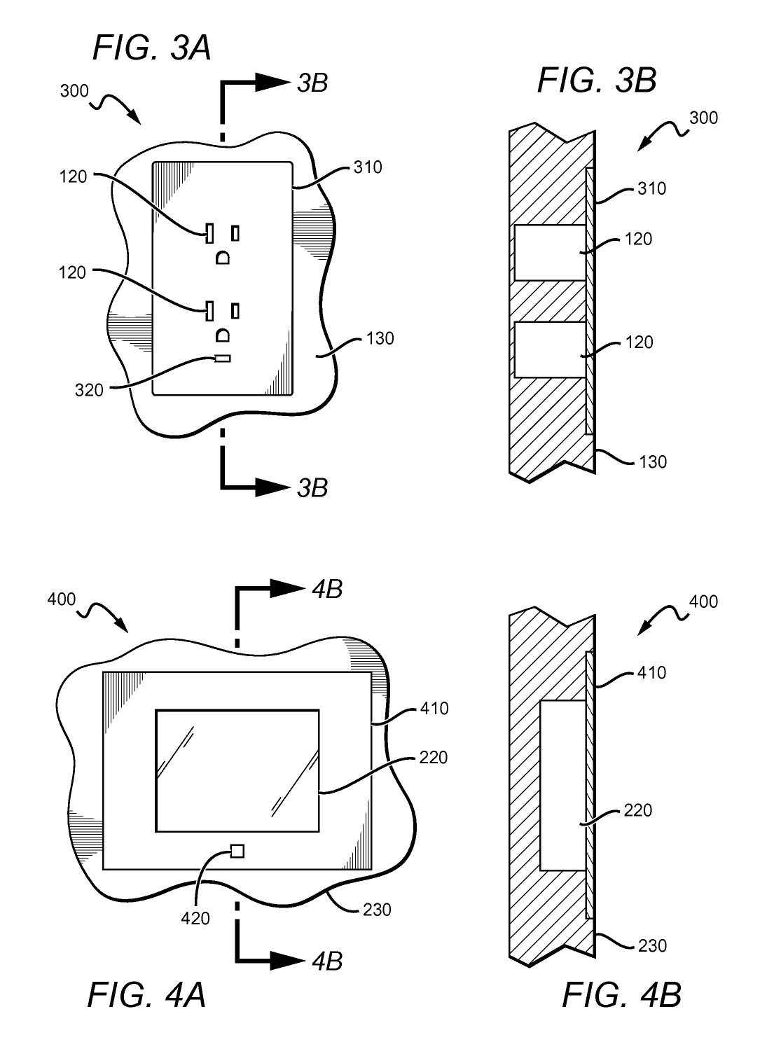

In FIGS. 3A-3B and FIGS. 4A-4B, the facia plates of power outlet 100 and touch screen 200 have been modified to have a “common familial appearance.” Here, power outlet 300 has a facia plate 310 that fits over female electrical connectors 120, but in this case power outlet 300 rests within a recess in structural barrier 130 so that the front surface of facia plate 310 and female electrical connectors 120 are flush-mounted relative to the front surface of structural barrier 130. As such, the facia plate has little or no prominence from the wall. Additionally, facia plate 310 has a distinctive logo 320 that identifies the manufacturer of the facia plate. In this case, the logo is the Trufig™ trademark, which comprises a square with a capitalized T within the square.

The facia plate of touch screen 400 has similar modifications. Facia plate 410 fits over screen 220, but is disposed within a recess in structural barrier 230 so that the front surface of facia plate 410 and screen 220 are flush relative to the structural barrier 230. Facia plate 410 also has a logo 420, which is once again the Trufig™ trademark. It should be noted that either or both of the flush-mount modification and the addition of a logo provides the components with a “common familial appearance.”

Any suitable method of obtaining a common familial appearance is contemplated. For example, different types of components could have a common distinctive polygonal or elliptical shape (e.g., ovals, stars, triangles, pentagons, circles) or cross-section. The distinctive polygonal or elliptical shape could be formed by the component itself, or preferably by a facia plate attached to a front surface of the component. Polygonal shapes could also be added as a pattern or a logo on the facia plate itself. For example a border of a set of facia plates could comprise a lines of stars, and that feature could provide a common familial appearance to the corresponding components. As mentioned above, rectangular and round shapes are not considered to be sufficiently distinctive, in and of themselves, to establish a common familial appearance. As defined herein, a “rectangular shape” does not need to be perfectly rectangular. Rectangular shapes include shapes that are substantially rectangular, for example by having rounded corners, or by having opposing sides that are not perfectly parallel.

Non-geometric shapes of facia plates are contemplated to be sufficiently distinctive to establish a common familial appearance. For example, hearts, letters, numbers, logos, and combinations thereof can establish a common familial appearance. Indeed, there are families of light fixtures that include moon shapes, star shapes, rocket ship shapes, and so forth, but in that case the components are all in the same category, namely light fixtures. To the best knowledge of the inventor(s) herein, it is not known for that family to extend to other categories, namely speakers, controllers, air vents, power/data interfaces, fire response devices, cabinetry, or cameras.

Alternatively or additionally, the front of components (or their corresponding facia plates) could achieve a common familial appearance by having a unique prominence from the wall. As defined herein, a “prominence” is a projection or a recess of a noticeable distance from a wall. By way of example, contemplated prominences are a concave pattern, a convex pattern, a wavy pattern, a protruding three-dimensional logo, and a recessed engraving. The visual cues that compose the common familial appearance do not need to be the same size and magnitude, and can indeed merely be proportional to one another.

Other visual cues can also be used, for example by covering a surface of the component with a certain color, finish, pattern or combination thereof. For example, a familial appearance could be a facia plate that protrudes out in a convex arc from the surface of the structural barrier. Or a combination of logos with specific colors could be engraved into the front surface of the component. Combinations of a prominence, a color, and a finish are especially preferred.

Contemplated distinctive common familial appearances include a fire alarm or sprinkler that is non-round (i.e. square, rectangular, triangular, rhomboid, pentagonal) or power outlets or data outlets with a front surface that is flush with a front of the wallboard. Preferably, devices that do not require interaction with a user, for example fire response devices, speakers, and cameras, are flush with the surface of the wallboard and is largely camouflaged or hidden from view. For example, a fire sprinkler could be hidden behind a flush facia plate that pops off when the sprinkler activates, or a camera could be placed behind a dark one-way glass in the midst of a black ceiling. Facia plates and mount shapes are especially preferred when they vary from the traditional shapes that are used in the prior art.

While FIGS. 3A-B and 4A-B only show a controller component and a power/data interface component sharing the same common familial appearance, any number of components (or their facia plates) from any number of categories could be designed to have a common familial appearance. For example, light switches, power outlets, speakers, and cabinetry for an entire wall of a building, or indeed an entire building, could share a common familial appearance.

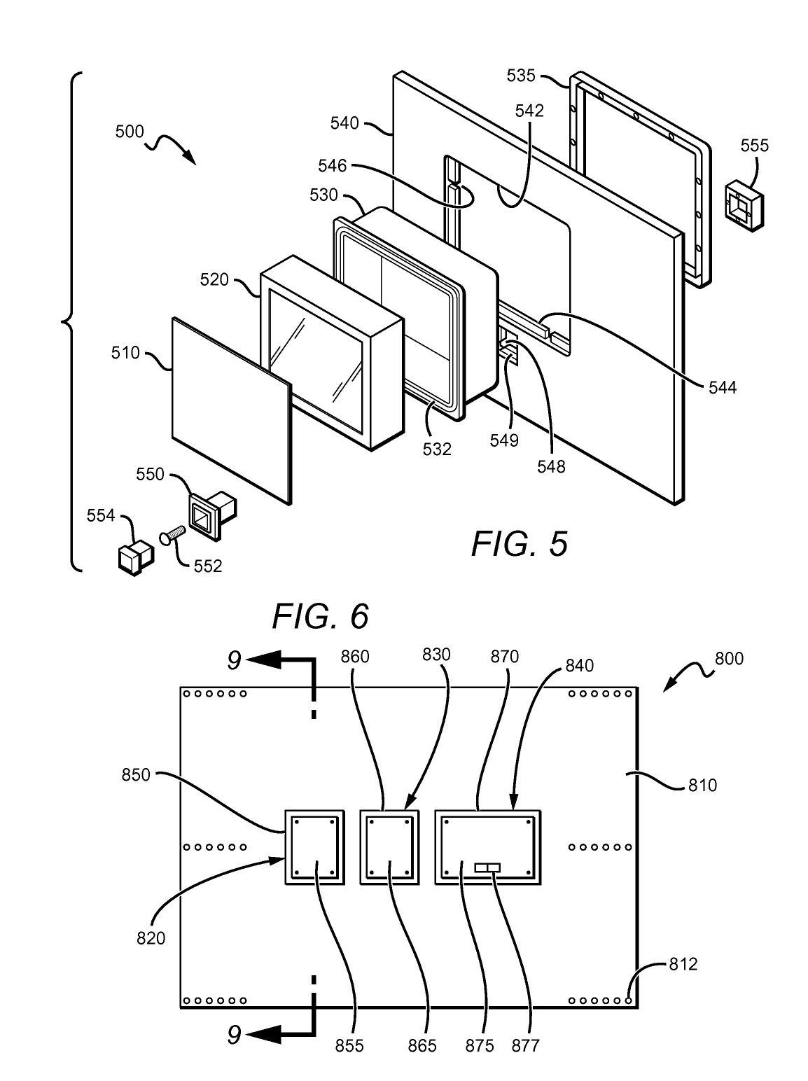

In FIG. 5, a panel 540 is used to mount a component 520 to a structural barrier (not shown). Generally, panel 540 has an opening 542 and recessed projections 544. Front bracket 530 and back bracket 535 clamp onto recessed projections 544, and then component 520 could be placed within the completed bracket. Lastly, facia plate 510 is placed over component 520 to cover at least a portion of the front of component 520.

Panel 540 is a piece of gypsum board, wood, plastic, or other material (or combination of materials) sufficiently strong to support a speaker or other desired component between two studs of a wall or door, or joists or other supports in a ceiling or floor. Thickness of the panel would likely depend on the thickness of the structural barrier. Where plywood is used as the panel material, for example, the panel might be as thin as ¼″ (6.35 mm), but would more preferably measure at least ½″ (12.7 mm) or ⅜″ (19.05 mm). Preferred materials include common plaster wallboard, Medium Density Fiberboard (MDF), High Density Fiberboard (MDF), Acrylonitrile Butadiene Styrene (ABS), and other materials that closely match various characteristics of drywall. Multiple materials could be mixed in with one another, could be alternating, or combined in any other suitable manner. Preferably, the moisture absorption and coefficient of thermal expansion of the material in the panel is the same or substantially the same as the surrounding structural barrier, while having greater durability and strength for attaching heavy components directly to the panel. For example QuietRock® 525 could be a paneling material used where the structural barrier comprises drywall.

Panel 540 is generally about twenty inches (about 50 cm) to twenty-four inches (about 60 cm) wide, but panel 540 can have any other suitable dimensions, even for example, up to the size to replace an entire sheet of structural barrier. Narrower panels are also contemplated, although they would likely not have a sufficient width to extend between wall studs or ceiling joists. It is preferable for the panel 540 to have a width of at least six inches (15.24 cm) or twelve inches (30.48 cm) greater than the spacing between studs, which allows the installer considerably greater flexibility in positioning the panel on the wall. Lateral wings (not shown) could be attached to the perimeter of panel 540 to extend the width for installations where the studs are spread apart at a greater distance from each other than normal. While panel 540 is shown as a substantially planar apparatus, panel 540 can be concave, convex, or any other shape to either match the shape of the structural barrier, or to introduce a non-planar surface to the structural barrier.

Opening 542 extends from a front side of panel 540 to a back side of panel 540. The “front side” of the panel is defined herein as the side of the panel that is facing outwards when the panel is installed to a structural barrier. The front side includes any spackle that may need to be spread over the front of the panel up to the spackling rim at the edge of the bracket. The “back side” of the panel is defined herein as the side of the panel that is directly opposite to the front side. As an opening extends from a front side of the panel to the back side, the opening necessarily links a front side of the structural barrier to the back side of the structural barrier when installed.

Opening 542 can also be of any suitable shape and size. Preferred openings are rectangular to accommodate common rectangular components, for example light switches, wall outlets, speaker volume controls, and home security systems. However, the openings could also be oval or circular or any other desired shape. The area of the opening is generally dependent on the size of the component, and can range up to 80 in² or larger. Especially preferred openings have an area of at least 20 in², 40 in², 60 in², and even 80 in². Nevertheless, for stability, it is contemplated that the panel have openings with a length that is no more than half or one third the length of the panel.

In some cases it may be desirable to include multiple openings for multiple components. Openings with varying height could be aligned along their top or bottom edges, aligned along a centerline, or could be arranged in a staircase fashion with a top edge aligned to a bottom edge. Openings could be cut at a job site or elsewhere by an installer, but are more conveniently precut (or molded to include the opening) at the manufacturer. It is possible for a panel to have punch out openings or perhaps cutout lines to facilitate selection of the position of the opening at the job site, but those options are currently disfavored relative to a manufactured pre-cut or molded opening and a relatively large panel.

Recessed projection 544 projects into opening 542 and is also slightly recessed from the front side of the panel. Recessed projection preferably extends more than 1 cm, 2 cm, or 5 cm into the opening but can extend a lesser distance depending on the strength of the panel. Recessed projection is also preferably recessed by about 1 cm from the front side of the panel, allowing ample room for the front bracket to be situated within the opening. Here, recessed projection has screw holes 546 that help front bracket 530 and back bracket 535 clamp onto the recessed projection, although screw holes are not necessary for front bracket and back bracket to clamp onto the recessed projection.

Front bracket 530 has an outer perimeter spackling rim 532 that rests against recessed projection 544 within the recess formed by recessed projection 544. Front bracket 530 has threaded screw holes that are spaced approximately 2 cm from the corners of spackling rim 532 and are approximately 3 cm deep, but can be shaped and configured in other suitable ways. Screws thread through screw holes in rear bracket 535 and into the screw holes in front bracket 530 to “clamp” the front bracket and rear bracket to the recessed projection, holding the bracket in place within the opening. After the bracket is situated, a component 520 can be fitted into bracket 530. While front bracket has a receiving portion that accepts component 520 and rear bracket merely acts as a “rim” that clamps front bracket and rear bracket against the recessed projection, rear bracket could also have a receiving portion that accepts the component without departing from the scope of the invention.

Component 520 is used euphemistically to refer to any suitable component in any category, for example plasma screens, in wall art panels, in wall cabinets, windows, wall outlets, security systems, fuse boxes, light switches, lighting, sprinkler systems, smoke detectors, and so forth. Here, component 520 is represented by a thin wafer that fits within bracket 530.

Facia plate 510 covers at least a portion of the front of component 520, and is preferably held in place with a magnetic coupling system that couples the facia plate either directly to the component or to the bracket. Facia plate 510 preferably also rests inside the recess formed by recessed projection 544 so that the front of facia plate 510 is flush with the front of panel 540. While facia plate is shown as a substantially rectangular plate, facia plate could be shaped and sized in any manner without departing from the scope of the invention.

A logo opening 548 and logo recessed projection 549 is situated below opening 542 so that a logo front bracket 550 and logo rear bracket 555 could couple to recessed projection 549. Logo 544 could then be coupled to bracket 550 using threaded screw 552. This way, the logo could be embedded directly into the panel instead of to the facia plate.

In FIG. 6 a component mounting apparatus 800 generally includes a panel 810 with multiple openings 820, 830, and 840. Each opening 820, 830, and 840, has a bracket 850, 860, and 870, and a spackle shield 855, 865, and 875, respectively. It should be appreciated that while each bracket is sized and dimensioned to hold a specific component, the brackets could be identical to one another to create a “universal bracketing system” that can hold components of various sizes. It should also be appreciated that while the panel has three openings, the panel could have only one or two openings, or more than three openings.

Receivers 812 are hole primers that are spaced approximately 1 inch (2.5 cm) from center, a diameter of 0.375 in (9.525 mm), and are approximately ¼ in (6.35 mm) deep, but can be shaped and configured in other suitable ways. A “hole primer” is a concave hole deepest in the center that helps an installer drill a screw or hammer a nail in a designated place without slipping. The diameter of the hole primer is preferably larger than the diameter of the screw head or nail head used so as to prevent the head of the screw or nail from leaving an unsightly bump on the surface of the structural barrier after spackling. Other suitable receivers are contemplated, for example visual marks or pre-drilled and threaded screw holes.

Each opening 820, 830, and 840 can also be of any suitable shape and size. Preferred openings are rectangular to accommodate common rectangular components, for example light switches, wall outlets, speaker volume controls, and home security systems. However, the openings could also be oval or circular or any other desired shape. The area of the opening is generally dependent on the size of the component, and can range up to 80 in² or larger. Especially preferred openings have an area of at least 20 in², 40 in², 60 in², and even 80 in². Nevertheless, for stability, it is contemplated that the panel have openings with a length that is no more than half or one third the length of the panel.

The openings 820, 830, and 840 are shown to be identical in height, and are aligned with one another in a row, but it should be appreciated that the openings do not have to have any shared dimensions, and could be positioned in any suitable arrangement relative to the panel 810. Openings with varying height could be aligned along their top or bottom edges, aligned along a centerline, or could be arranged in a staircase fashion with a top edge aligned to a bottom edge. Openings could be cut at a job site or elsewhere by an installer, but are more conveniently precut (or molded to include the opening) at the manufacturer. It is possible for a panel to have punch out openings or perhaps cutout lines to facilitate selection of the position of the opening at the job site, but those options are currently disfavored relative to a manufactured pre-cut or molded opening and a relatively large panel.

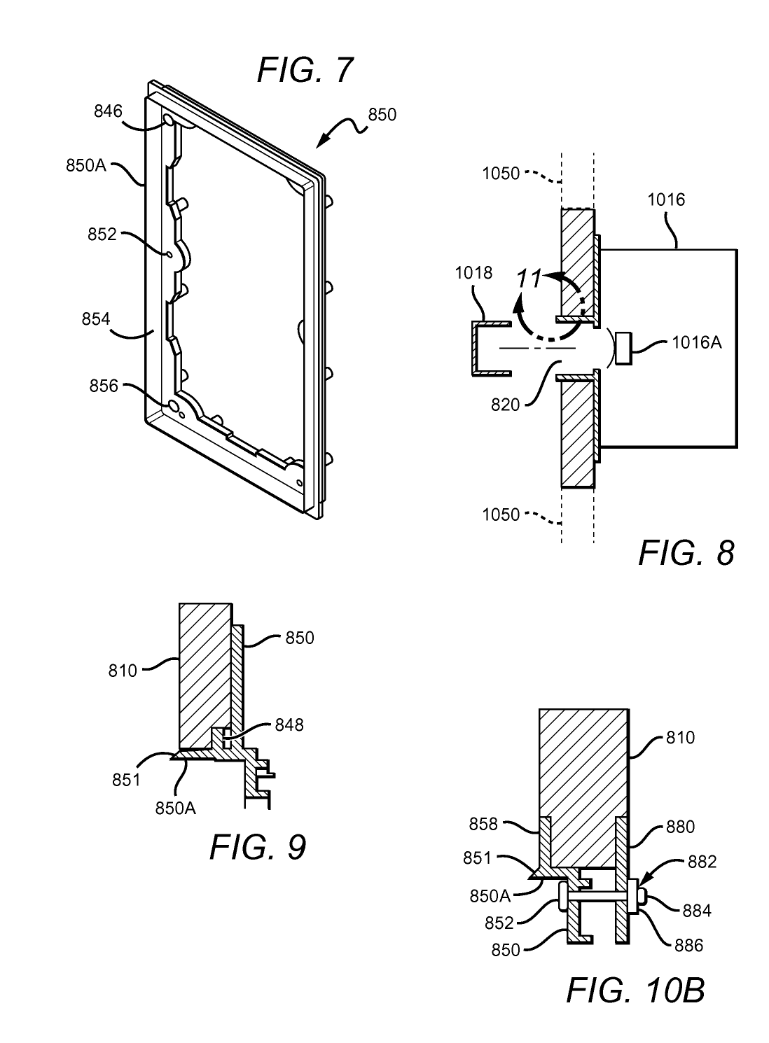

Brackets 850, 860, and 870 are preferably sized and dimensioned to fit snugly into the openings 820, 830, and 840, but in any event are screwed, glued, clamped, or are otherwise securely attached to the panel 810. The secure attachment is important since in at least some embodiments, the component housing will be attached to the bracket rather than being directly attached to the panel 810. The brackets are preferably molded from polyethylene or other sufficiently strong and durable thermoset plastic, and as shown in greater detail in FIG. 7 bracket 850 includes holes 852 for screws (not shown), a recess 854 into which a component cover 110 can be removably secured via a holding mechanism, and a rim 850A, and optional magnets 856 or an optional press fit (not shown).

Spackle shields 855, 865, and 875 preferably cover the opening of the brackets to prevent mud or drywall from splashing to the other side of the panel, and can be removed after spackling. This is particularly helpful for when an electronic component is pre-installed behind the panel before spackling. Spackle shield 875 can have optional level 877 to help ensure that the panel is being installed horizontally. While level 877 is shown as a standard spirit level, any device that ensures that the panel is level is appropriate. Other devices that assist in installation can be provided in the spackle shield, for example a laser leveler to help align several panels with one another or a compartment that stores extra screws and magnets.

The components mounted to brackets 850, 860, and 870 can be any components mounted to a wall, for example speakers, plasma screens, in wall art panels, in wall cabinets, windows, wall outlets, security systems, fuse boxes, light switches, lighting, sprinkler systems, smoke detectors, and so forth. While the brackets and openings are generally shaped and sized to fit particular electronic devices, for example a rectangle for a light switch or a circle for a ceiling light, the universal brackets may be used that can accommodate a variety of electronic devices. To fit the component to a universal bracket, the component could consist of an outer casing that fits around the electronic device and couples to the universal bracket.

Several such panels 810 could be used to comprise a family of component panels. Preferably, at least three, five, or more members make up each family, so that a large variety of panels could be used for installation. Panel families do not necessarily correlate with a familial appearance, and a family of brackets could be spread among multiple panel families or vice-versa.

FIG. 8 also shows a component 1016 and a component cover 1018. Component 1016 is shown having speaker 1016A, but component 1016 could be any practical component, including especially speakers, lights, air conditioners, or any other component that is typically larger than its external opening. The various wires for power and signal are not show in the Figures, but could be assumed, and can be those conventionally contemplated in the art. Component cover 1018 can be any suitable grille, but is preferably a metallic mesh grille that press-fits into the opening 820. Additionally or alternatively, the component cover can include a ferrous material that is attracted to magnets 856 in bracket 850.

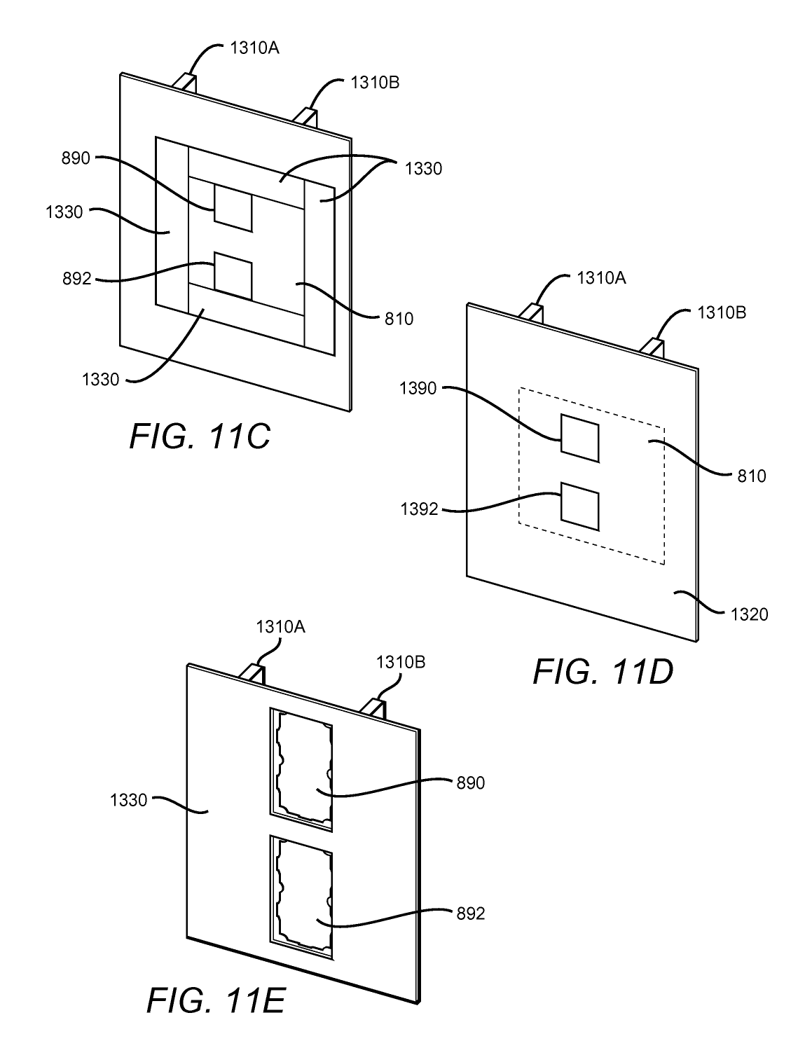

As seen in FIG. 9 the rim 850A is sized and dimensioned to extend outwardly beyond a front of the panel 810 by a very small distance 851, which provides a lip that can readily be used as a stop against which to spread a spackling compound, for example plaster or drywall. Preferred such distances 851 are less than ⅛ inch, and preferably about 1/16 inch, or in metric terms about 1-3 mm. Preferably, the panel has a thickness of at least ¼ inch (6.35 mm). Also shown in FIG. 11 is an attachment member 858 that helps secure bracket 850 to panel 810. A screw hole (not shown) can be provided in attachment member 158 to help affix bracket 850 to panel 810.

It should be appreciated that the rim could be separable from the panel. Thus, for example, the rim could be a separately molded piece of plastic, metal or composite that is installed into the opening by the installer, or at a factory.

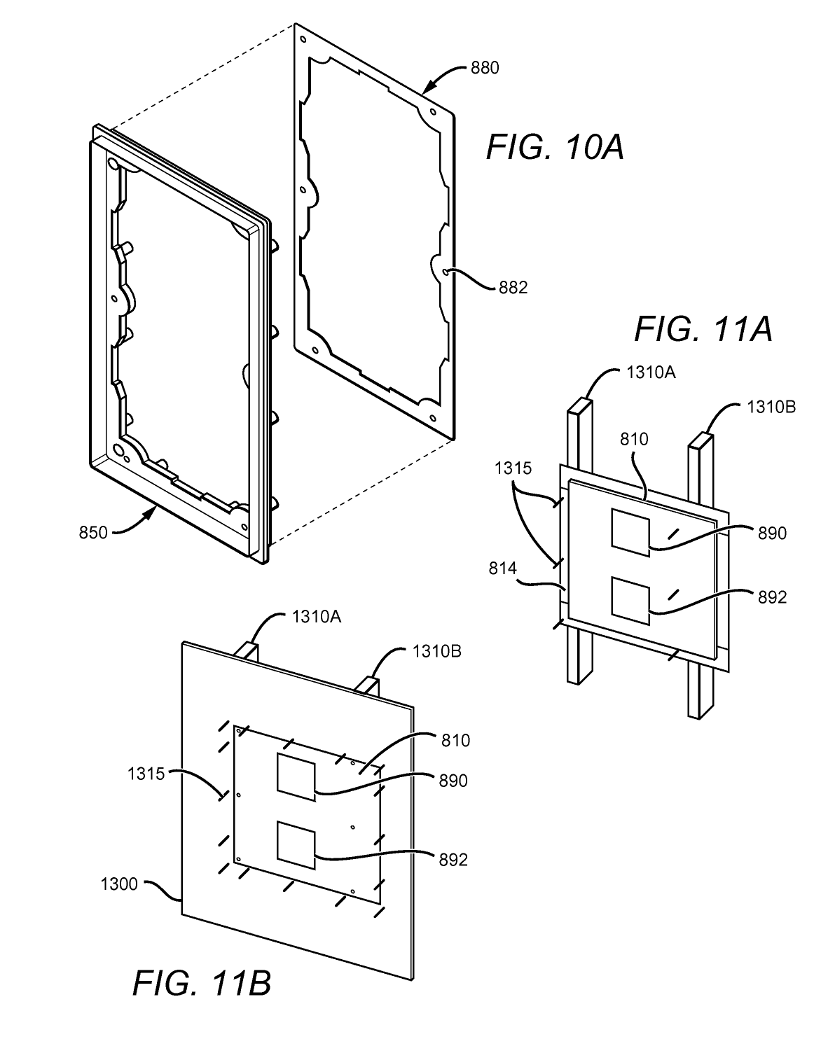

As seen in FIGS. 10A and 10B, a bracket backing 180 with screw holes 882 could be used to clamp bracket 850 to panel 810. In this embodiment, attachment member 858 fits within recess 814 on the front of panel 810 and bracket backing 880 fits within recess 816 on the back of panel 810. Screw 884 threads through screw holes 852 and 882, and finally through nut 886 to provide a clamping force around panel 810. Clamping bracket 850 to panel 810 provides a secure connection without the need for expensive glues or adhesives.

In FIG. 11A, the panel 810 is affixed to two studs 1310A, 1310B in a wall, and screws 1315 are inserted through hole primers 812 and the panel 810 on the right side, and through an attached flange 814. Panel 810 shows openings 890 and 892 with the spackle shields covering the brackets. Of course, the positioning and orientation of the panel could be varied in any suitable manner with respect to the studs, 1310A, 1310B, including moving the panel 810 higher or lower, left or right, or even tilting the panel clockwise or counterclockwise. Similarly, the studs should also be interpreted herein as emblematic of any support structures of a wall, whether or not such structures are technically considered to be studs. In addition, a greater or lesser number of screws could be used, or inserted in some other arrangement than that shown to provide greater or lesser support. The screws could also be replaced or supplemented by some other attachment means such as an adhesive.

Those skilled in the art will appreciate that the combination of panel and bracket could be provided in several different ways. The panel and bracket could, for example, be joined together at a job site, and indeed the panel could even be “manufactured” at the job site by cutting or punching out the opening. More preferably, however, the panel and bracket are provided as an item of manufacture to the installer by a supplier or manufacturer. The rim of the panel can be pre-installed to the panel. Thus, in various embodiments a kit could contain one or more of a panel, a bracket (or at least a rim around the edges of an opening in the panel), a speaker housing, a spackle shield, and installation screws. The installer would then provide whatever labor is appropriate for the installation, including optionally installing the bracket and/or rim, optionally installing the spackle shield, and optionally mounting the speaker into the speaker housing to the back side of the panel. It is also contemplated that the speaker can be pre-installed into the panel before installation. Alternatively the combination of the panel and bracket can be mounted before installing a rim on the opening.

In FIG. 11B drywall 1320 or other structural barrier has been installed on all four sides around the panel 810, and coupled to the wings using screws 1315. Where wings are present, as in the embodiment depicted, the drywall 1320 overlays the wings, but the wings are sufficiently thin so that the drywall is not noticeable raised. Those skilled in the art will appreciate that although FIG. 11B shows the drywall 1320 surrounding the panel 810 as a single piece, it is entirely possible that the drywall could comprise multiple pieces (not shown). It is also contemplated that installation of the drywall 1320 might be delegated to drywaller or other tradesman distinct from the panel installer. Nevertheless, the process of installing the panel on one or more wall supports is deemed to include the step of positioning the panel so that it can be approximated in an end-to-end fashion by a piece of structural barrier or other wall section.

In FIG. 11C mesh tape 1330 is applied along the juxtapositions or other approximations between edges of the panel 810 and edges of the drywall 1320. Here again, this step is usually delegated to a professional drywaller, but could be accomplished by the installer of the panel, regardless of which person actually does the work.

In FIG. 11D the mesh tape is covered by a spackling compound, and is ready for painting, wallpapering, or other surface coating. Preferably, the spackling compound is smoothed over the entire front surface of the panel to the lips of openings 890 and 892. As used herein, the terms “spackle” and “spackling” should be interpreted as broadly as possible, to include for example plaster and plastering of any type. One objective is to provide a smoothed out surface that completely or substantially hides the joints between edges of the panel and edges of the drywall

In FIG. 11E, the spackle shields are removed from openings 890, 892, and components can be installed in the new uniform structural barrier 1330.

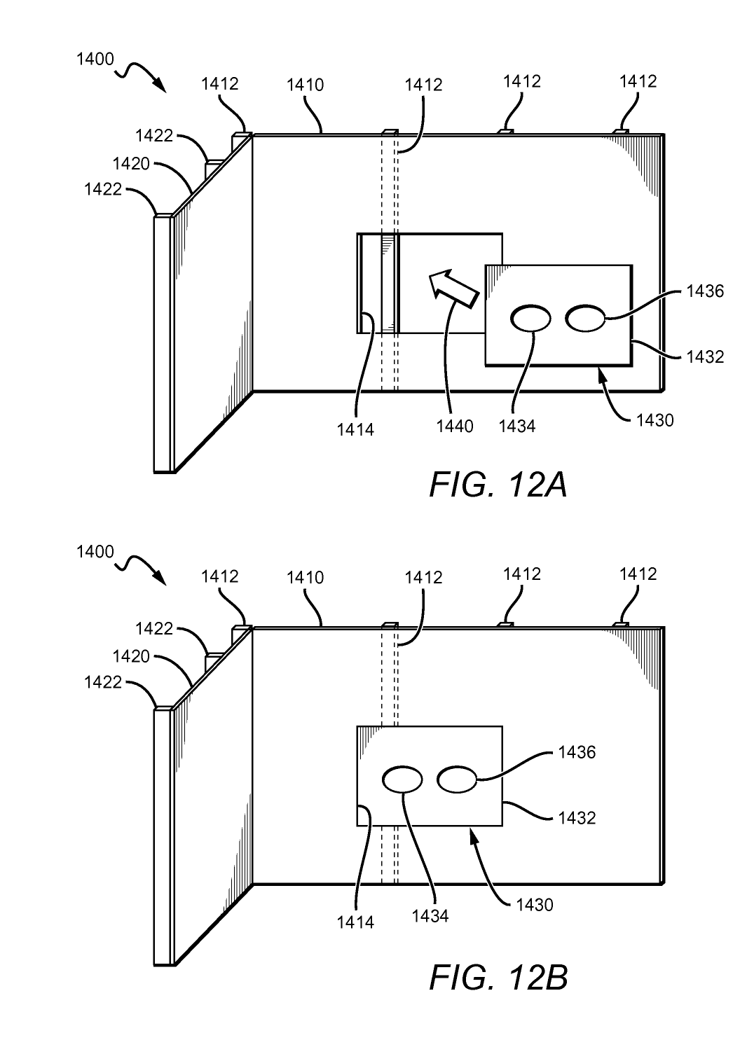

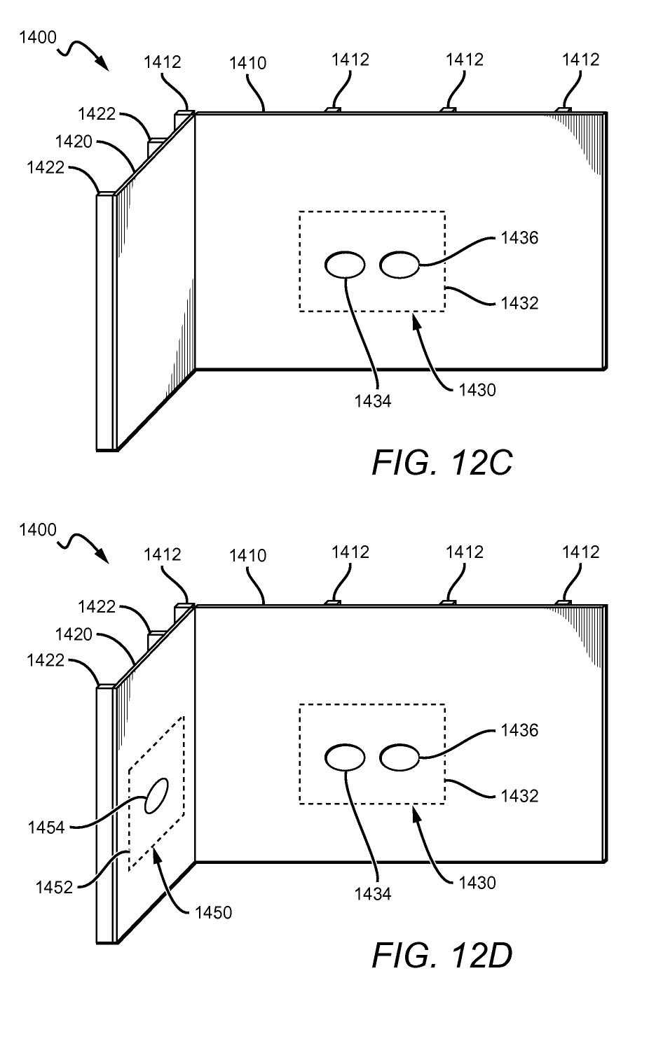

In FIG. 12A an installation 1400 generally includes structural barriers 1410, 1420, an opening 1414 on structure 1410, and a panel assembly 1430 that will installed into the space 1414, as shown by arrow 1440.

As used herein, the term “assembly” means an object that has multiple components or functional portions. Thus, the term comprises: (a) multiple pieces that are coupled together in some manner, either temporarily or permanently; and also (b) a single molded object with multiple functional components. By way of example, panel assembly 1492 in FIG. 14 is a panel assembly molded as a single piece.

In typical installations, the structural barriers 1410, 1420 would be adjacent vertical walls, or a vertical wall and a ceiling, and FIG. 14A should be interpreted to include all such embodiments. Thus, for example, where structural barriers 1410, 1420 are interpreted to be vertical walls, members 1412, 1422 could be studs. Where structural barrier 1410 is interpreted as a ceiling, members 1412 could be joists, and members 1422 could be horizontal struts. Although the portions of the structural barriers 1410. 1420 depicted in the figure as substantially flat, those skilled in the art will appreciate that the structures could be curved, or have curved portions. In addition, those skilled in the art will appreciate that structural barrier 1410 could exist independently of structural barrier 1420.

Structural barriers 1410, 1420 would typically comprise drywall, which term is used herein generically to include all manner of structural barrier, fiberboard, gypsum board, GWB, plasterboard, Sheetrock® and Gyproc®, and so forth. Additionally or alternatively, structural barriers 1410, 1420 could comprise other materials, including for example polymers, masonry, ceramics, and acoustic ceiling tile materials or other composites.

Structural barriers 1410, 1420 can have any suitable dimensions, from only a few square feet or less, to hundreds of square feet or more. Structural barriers 1410, 1420 will usually, however, have relatively small thicknesses of between ¼″ and 1″ in thickness.

Panel assembly 1430 can be produced at a job site, for example, by cutting a hole out of a piece of drywall. The piece being used in such instances can be cut out from an existing vertical wall or ceiling, and or can be completely new to the job site. Either of those methods could work adequately for drywall, acoustic ceiling tile and other materials that are fairly easy to cut, but for difficult to cut materials, including for example polymers, masonry, and ceramics, the panel assembly can be most conveniently produced in a factory where the panel is dried or cured around a form (see FIG. 14) to define the opening.

As discussed above with respect to FIGS. 6-11, the openings 1434, 1436 of FIG. 14A can be any suitable size, shape, or number. As currently contemplated, it is desirable that the total front facing area consumed by the openings be relatively small with respect to that of the panel 1432. That ratio is preferably at least 3, more preferably at least five. Viewed from another perspective, it is preferred that the panel 1432 extend in at least one direction at least 3 inches (7.62 cm) from the closest edge of the openings 1434, 1436 for light or other simple switches, electrical outlets and so forth, and at least 5 inches (12.7 cm) for lights, more complicated switches and other controllers, speakers and so forth. Where the component has a front-facing surface area of at least 25 in² (about 860 cm²), the panel 1432 extends in at least one direction at least 12, 18, or even 24 inches (about 30, 45, or 60 cm) from the closest edge of either opening 1434 or 1436.

In FIG. 12B the panel assembly 1430 has been placed within the space 1414. There will almost always be some gap between the edges of the panel assembly 1430 and those of the surrounding structural component 1410, ranging in typical installations from zero (where the panel assembly 1430 is abutted against the structural component 1410), and perhaps ⅛″ (3.175 mm) to ¼″ (6.35 mm). Indeed, there will almost always be multiple different gaps around the edge of the panel assembly. Where the workmanship is sloppy, or the project is especially difficult, the gap in some sections can be larger. In addition, it is contemplated that an intermediate member (not shown), as for example a paper, shim, or even a frame can be installed in the gap between the panel assembly 1430 and the structural component 1410. As long as the edges of the assembly and the structural barrier are somewhat near each other, and the gap can be finished and concealed such that an at least superficially continuous junction is established between them, the edges are considered to be approximated.

In FIG. 12C the approximated edges of the panel assembly and the structural barrier have been finished to provide an at least superficially continuous junction. As used herein the term “at least superficially continuous junction” refers to a junction that appears to casual observation to be seamless. By way of example, a good workman-like job in taping and plastering adjacent sections of wall board is considered herein to produce an at least superficially continuous junction, especially where subsequent painting or wallpapering eliminates any seam apparent to casual observation.

In FIG. 12D a second panel assembly 1450 has been installed in a second structural barrier 1420 and to studs 1422. This allows a third component to be installed into opening 1454. Panel 1432 and 1452 are from the same family and have identical openings 1434, 1436, and 1454 that accept a variety of different components from different categories. By way of example, a flush-mount wall outlet could be installed in opening 1454, a flush-mount control panel could be installed in opening 1434, and a flush-mount television could be installed in opening 1436, and all would have the same common familial appearance of having a front surface that is completely flush with the surface of the structural barrier. This flush-mount surface would be distinctive from other wall-mounted components and gives the entire room a unified appearance.

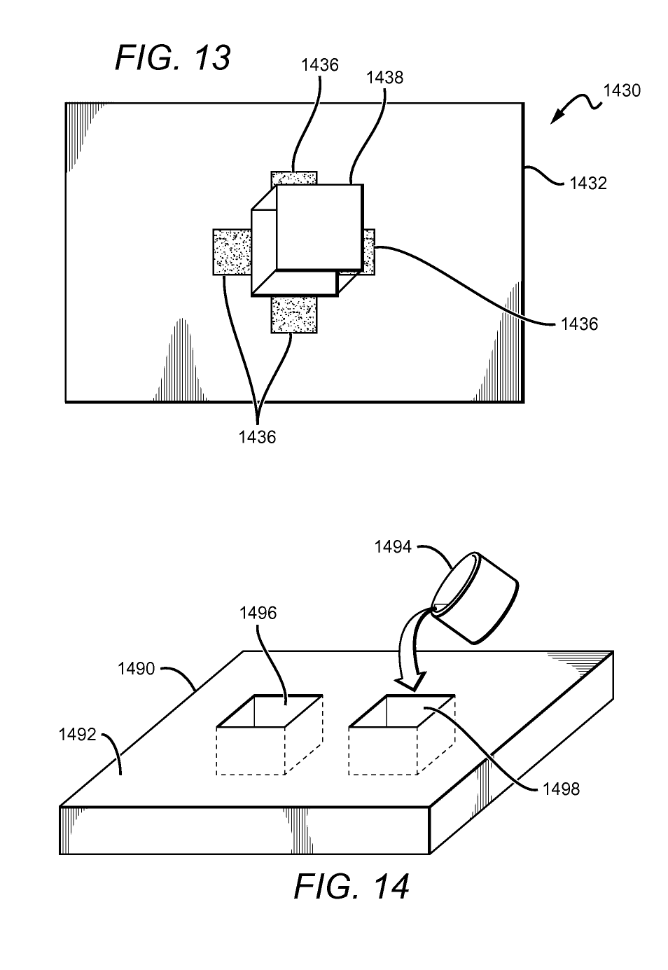

In FIG. 13, a rear view of the panel assembly 1430 of FIGS. 14A-14C shows a receiver 1438 and attachments 1436 of the receiver to the panel 1432. The receiver 1438 in this instance is an open box, but all manner of alternative receivers are also contemplated. For example, receivers could be tubular or have some other shape, could be completely or partially closed, could be larger, smaller, or the same size as the opening, and can have punch outs such as those found on a typical electrical connection box. An exemplary receiver made to accept an electrically powered component could have electrical connections that mate with electrical connections on the component as the component is pushed into the receiver. Preferably, the electrical connections both power the component, and connect the component to other electrical devices.

The attachments 1436 are shown as four wings, extending from the four sides of the receiver 1438, and then glued, nailed, stapled or otherwise affixed to the panel 1432. Those skilled in the art will appreciate that still other methods could be used, including forming the panel 832 around the wings or attaching the receiver to a bracket on panel 1432. Still further, it is contemplated that wings could be eliminated altogether. In a ¾″ or 1″ thick fiberboard, for example, a collar pressed into the opening, or used as a form around which the fiberboard is made, might have sufficient strength to hold a relatively lightweight component. In an exemplary embodiment, attachments 1436 are screws that attach the receiver 1438 to a front receiver in front of the panel (not shown) so that the two clamp around the panel.

FIG. 14 is a perspective view of a panel assembly 1492 being formed by pouring a panel material from container 1432 into a mold 1494. This process brings the poured material right up against the frame portion that defines the openings 1496 and 1498, regardless of any irregularity or other difficulties with the shape of the opening. All manner of panel materials are contemplated, including for example curable plastics, and masonry composites. The panel could also be cut and routed one or more layers of panel materials.

Thus, specific embodiments and applications of installing components from different categories to a structural barrier to achieve a common familial appearance have been disclosed. It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of mounting multiple components to one or more ceiling or wall structural barriers in a building, comprising:
installing at least n of the components to the one or more surfaces in a manner that achieves a common familial appearance;
wherein n is 3, and each of each of the n ones of the components fall into different ones of the following categories: speakers, lighting, controllers, air vents, power/data interfaces; fire response devices, cabinetry, and cameras.

2. The method of claim 1, wherein the common familial appearance derives at least in part from replacing n faceplates disposed over the n ones of the components, respectively.

3. The method of claim 1, wherein the common familial appearance comprises a geometric shape other than round and rectangular.

4. The method of claim 1, wherein the common familial appearance comprises at least one of a polygonal vertical cross-section and an elliptical vertical cross-section.

5. The method of claim 1, wherein the common familial appearance comprises a prominence.

4. The method of claim 1, wherein the common familial appearance comprises a prominence, a color, and a finish.

5. The method of claim 1, wherein n is 4.

6. The method of claim 1, wherein n is 5.

7. The method of claim 1, further comprising installing each of the n components on a single structural barrier.

8. The method of claim 1, further comprising installing at least one of the n the components across a first structural barrier, and less than n of the components in a second structural barrier, the first and second structural barriers disposed in a single room of the building.

9. A system for mounting multiple components to one or more surfaces of a building, comprising:
a family of panels having at least three members, wherein each of the members has a front surface area of at least 25 in², and each of the members defines an opening of at least 5 in²;
a family of brackets having at least two members; and
each of the panels adapted to receive at least one of the bracket members adjacent at least one of the openings, respectively.

10. The system of claim 9, wherein different members of the family of panels have different numbers of the openings.

11. The system of claim 9, wherein different members of the family of panels have different ones of the openings in different positions.

12. The system of claim 9, wherein at least one of the members of the family of panels has a spackle rim about a selected one of the openings.

13. The system of claim 9, wherein a first one of the component receiving boxes defines an internal area at least 25% larger than a second one of the component receiving boxes.
